(19) United States
(12) Patent Application Publication
(10) Pub. No.: US 2020/0080568 A1
(43) Pub. Date: Mar. 12, 2020

(54) FAN BLADE AND BLADE HUB ASSEMBLY

(71) Applicant: Vornado Air LLC, Andover, KS (US)

(72) Inventors: Glen W. Ediger, North Newton, KS (US); Gregory Pease, Andover, KS (US)

(73) Assignee: Vornado Air LLC, Andover, KS (US)

(21) Appl. No.: 16/563,843

(22) Filed: Sep. 7, 2019

Related U.S. Application Data
(60) Provisional application No. 62/728,402, filed on Sep. 7, 2018.

(51) Int. Cl. F04D 29/38; F04D 29/32

(52) U.S. Cl. CPC F04D 29/38; F05D 2230/64; F05D 2300/43; F04D 29/329

(57) ABSTRACT

The present invention provides an improved blade and blade hub assembly. According to a first preferred embodiment, the present invention provides an apparatus for attaching light-weight foam blades onto an injection molded hub to be used in an unguarded fan assembly. According to a further preferred embodiment, the present invention preferably further provides a foam blade design in which the more centrally located portion of the blade is inserted into slots that are molded into an injection molded hub. According to a further preferred embodiment, the slots of the present invention preferably keep the blade in a desired camber and support the blade in the proper angle and orientation.

The present application claims priority to U.S. Provisional Application No. 62/728,402, filed Sep. 7, 2019, which is hereby incorporated by reference herein.

### BACKGROUND AND FIELD OF THE PRESENT INVENTION

### Field of the Present Invention

The present invention is related in general to an improved fan design, and in particular, to an improved blade and blade hub assembly.

### Background of the Invention

Modern fans generally require rigid fan blades which are protected by rigid fan grills. Further, the spacing of all rigid grill elements on each fan grill must carefully match relevant UL requirements. These requirements greatly limit the design and engineering of each fan. This greatly reduces consumer choice and limits other aspects of fan engineering such as fan weight, size and overall appearance.

To overcome the limitations of the prior art, what is needed is a new design which is capable of meeting UL requirements while allowing the fan to operate without a grill. The present invention overcomes the prior art shortcomings by accomplishing this critical objective.

### SUMMARY OF THE DISCLOSURE

To minimize the limitations found in the prior art, and to minimize other limitations that will be apparent upon the reading of the specifications, the preferred embodiment of the present invention provides an improved blade and blade hub assembly.

According to a first preferred embodiment, the present invention provides an apparatus for attaching light-weight foam blades onto an injection molded hub to be used in an unguarded fan assembly.

According to a further preferred embodiment, the present invention preferably further provides a foam blade design in which the more centrally located portion of the blade is inserted into slots that are molded into an injection molded hub.

According to a further preferred embodiment, the slots of the present invention preferably keep the blade in a desired camber and support the blade in the proper angle and orientation.

According to a further preferred embodiment, each blade of the present invention may preferably be further supported in a front-to-back orientation by ribs that project in towards the hub center.

According to a further preferred embodiment, the ribs of the present invention preferably further include small pins to align the blade into a proper thrust orientation. Additionally, the pins may preferably be heat staked (thermoplastic staked) to permanently secure the blade to the hub and to provide further support to the blade.

These and other advantages and features of the present invention are described with specificity to make the present invention understandable to one of ordinary skill in the art.

### BRIEF DESCRIPTION OF THE DRAWINGS

FIG. 1 shows an exemplary fan assembly in accordance with a first preferred embodiment of the present invention.

FIG. 2 shows an enlarged, cross-sectional view of a fan hub assembly in accordance with a first preferred embodiment of the present invention.

FIG. 3 shows an exemplary fan blade in accordance with a preferred embodiment of the present invention.

FIG. 4 shows a cross-sectional plan view of the exemplary fan assembly as shown in FIG. 1.

FIG. 5 shows a cross-sectional perspective view of the exemplary fan assembly shown in FIG. 4.

### DESCRIPTION OF THE PREFERRED EMBODIMENTS

Reference is now made in detail to the exemplary embodiments of the invention, examples of which are illustrated in the accompanying drawings. Wherever possible, the same reference numbers will be used throughout the drawings to refer to the same or like parts. The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. As used throughout this application, the word “may” is used in a permissive sense (i.e., meaning “having the potential to’), rather than the mandatory sense (i.e. meaning “must”).

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

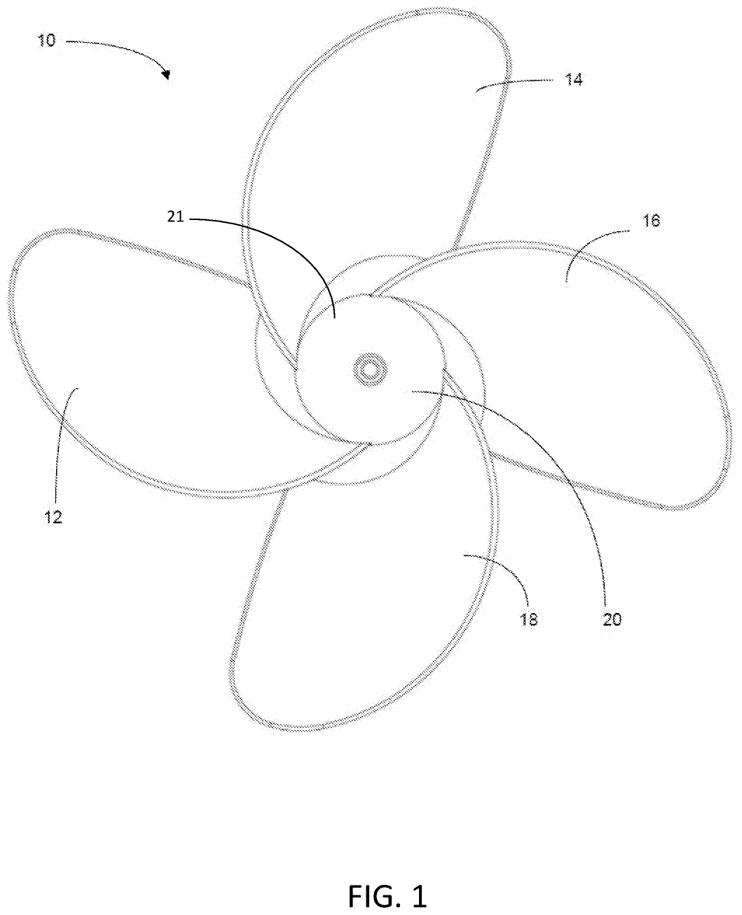

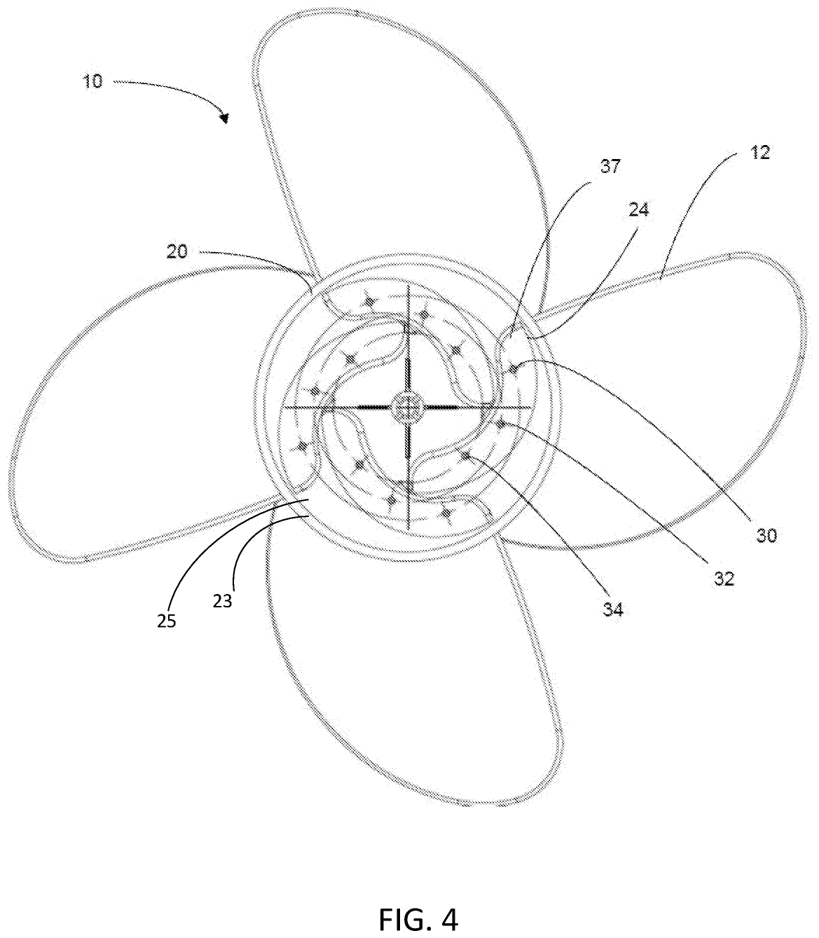

FIG. 1 illustrates an exemplary fan assembly 10 in accordance with a first preferred embodiment of the present invention. As should be understood, the fan assembly 10 disclosed in FIG. 1 is an exemplary fan assembly onto which the features of the present invention may be integrated. For example, the present invention is discussed with respect to a group of four fan blades 12, 14, 16, 18 which are attached to a center fan hub assembly 20. The fan hub assembly 20 as discussed herein may preferably be formed of a rear supporting shell 23 (shown in FIG. 4) and a front nose cone 21. It should be understood that the present invention may include any number fan blades (i.e. 2-20) which may be in any orientation. For instance, the fan blades may be tilted forward or backwards to adjust air flow patterns. Accordingly, FIG. 1 is intended to be purely illustrative and any of a variety of fan blade and fan hub orientations may be used with the present invention without limitation.

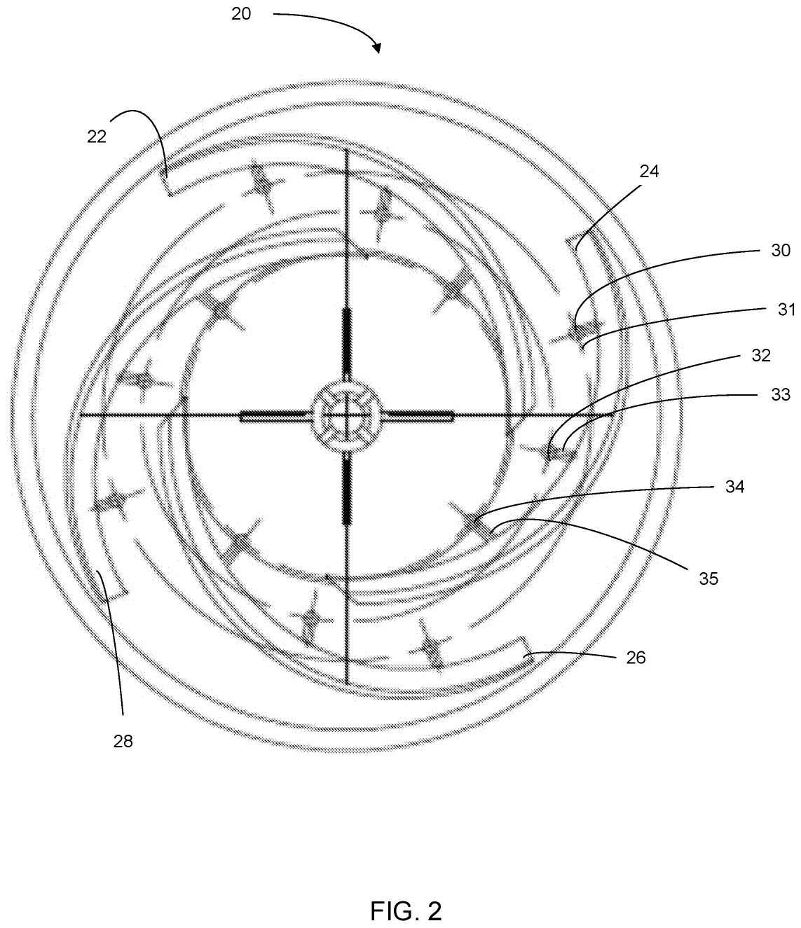

FIG. 2 shows an enlarged, cross-sectional view of the exemplary fan hub assembly 20 in accordance with a first preferred embodiment of the present invention. As shown, the exemplary fan hub assembly 20 includes fan blade insertion apertures 22, 24, 26 and 28 which are preferably of sufficient width and length to allow the fan blades of the present invention to be inserted therethrough as discussed further below.

According to preferred embodiments, the fan blade insertion apertures 22, 24, 26, 28 are preferably further sized to keep the fan blades 12, 14, 16, 18 in a desired contoured, camber. Further, the fan blade insertion apertures 22, 24, 26, 28 preferably further support holding the fan blades 12, 14, 16, 18 in the proper angles and in the proper front-to-back orientations.

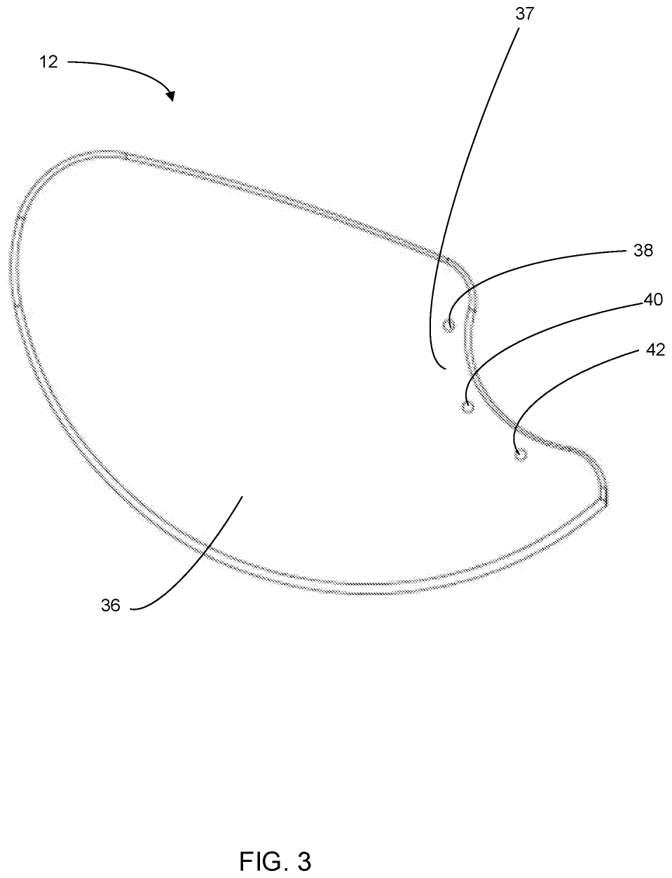

As further shown in FIG. 2, the fan blades 12, 14, 16, 18 (shown in FIG. 1) are preferably further secured and supported in a desired front-to-back orientation by a number of ribs 31, 33, 35 (shown in FIG. 2) which preferably extend through the surface of the fan hub assembly 20. Preferably, a securing points/pins 30, 32, 34 further extend up from each supporting rib 31, 33, 35 to align each respective fan blade 12, 14, 16, 18 (shown in FIG. 1) into a proper thrust orientation as well as to generally secure each fan blade in place. As shown in FIG. 3, three pins 30, 32, 34 may preferably be used. Alternatively, any number of pins (i.e. 1-10) may be used to secure each respective fan blade 12, 14, 16, 18 as discussed above.

Preferably, the fan hub assembly 20 of the present invention is preferably formed of molded materials and may be formed using an injection molding process. Accordingly, the fan blades 12, 14, 16, 18 and the fan hub assembly 20 may be formed of materials such as: Polypropylene (PP), High Density Polyethylene (HDPE), Low Density Polyethylene (LDPE), ABS Plastics, Acrylic, Polyurethane (PU), Nylon (PA), Thermoplastic Elastomer (TPE), Thermoplastic Polyurethane Elastomer Engineering Thermoplastic, Polycarbonate (PC), Polystyrene (PS), High Impact Polystyrene (HIPS), Polybutylene Terephthalate (PBT), Polyetherimide (PEI), Polyphenylene Sulfide (PPS) and the like.

With reference now to FIG. 3, an exemplary fan blade 12 in accordance with a preferred embodiment of the present invention is shown including a main blade surface 36 and an insertion edge 37. According to a preferred embodiment, the insertion edge 37 is preferably sized to allow insertion within a fan blade insertion aperture 22, 24, 26, 28. As further shown, the insertion edge 37 preferably further includes insertion holes 38, 40, 42 which are preferably sized to snap onto respective securing pins 30, 32, 34 to hold the fan blade 12 in place.

According to further preferred embodiments of the present invention, the exemplary fan blade 12 is preferably formed of a light-weight foam material. Such foam material may include open or closed cell materials and may include for example: Crosslinked Polyethylene, ethylyene-vynyl acetate (EVA), Volara, FloTex, Neoprene and the like. According to a further preferred embodiment, the fan blade 12 is preferable molded into a desired blade profile, shape, and contour using injection molding or the like. The insertion edge 37 of each fan blade 12 may then preferably be inserted into a fan blade insertion aperture 22, 24, 26, 28 and each insertion hole 38, 40, 42 may be snapped onto a respective securing pin 30, 32, 34.

Preferably, since each respective fan blade 12, 14, 16, 18 has flexibility, they preferably may be inserted into a respective fan blade insertion aperture 22, 24, 26, 28 and bent to allow the holes in each fan blade 12, 14, 16, 18 to fit onto securing pins molded into the hub assembly 20. This preferably allows for secure and proper alignment. According to a further preferred embodiment, each securing pin 30, 32, 34 may preferably be heat staked to permanently secure the blade 12 to the hub assembly 20 and to further support the blade 12 in a front-to-back orientation.

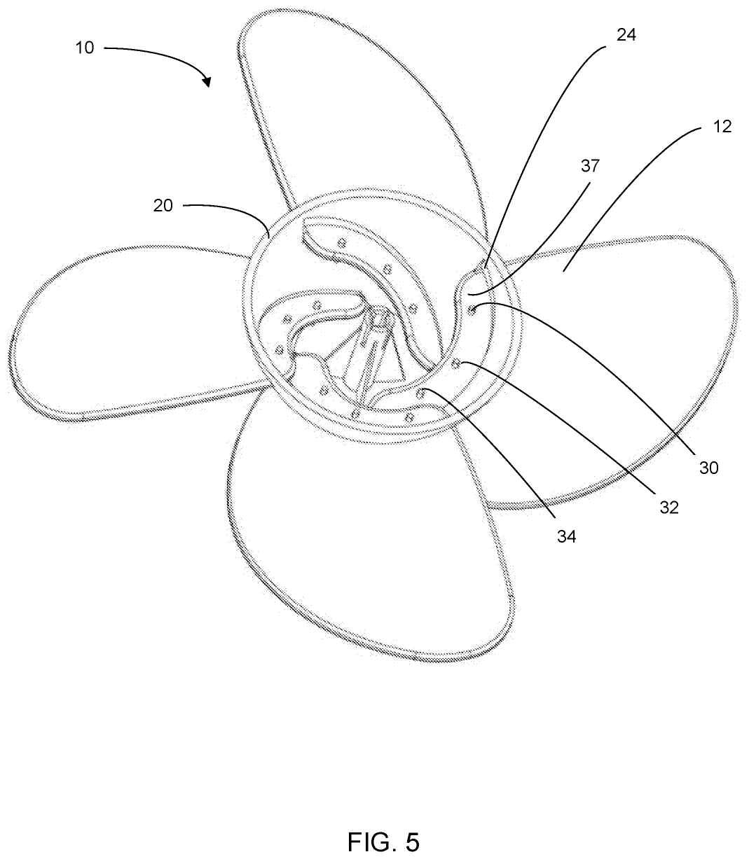

With reference now to FIG. 4, a cross-sectional plan view of the exemplary fan assembly 10 as shown in FIG. 1 is provided. Specifically, the hub assembly 20 is shown with the front nose cone 21 (shown in FIG. 1) removed and the rear supporting shell 23 open. As shown, the rear supporting shell 23 includes a curved inner housing surface 25 which includes fan blade insertion apertures 22, 24, 26, 28 (shown in FIG. 3). As shown, the insertion edge 37 of the example fan blade 12 is inserted through a fan blade insertion aperture 24 of the hub assembly 20. As further shown, the insertion edge 37 is snapped onto securing pins 30, 32, 34 to secure the fan blade 12 in place. FIG. 5 provides a further cross-sectional perspective view of the exemplary fan assembly 10 with the insertion edge 37 of the example fan blade 12 snapped onto the securing pins 30, 32, 34.

According to further preferred embodiments, the present invention may preferably be used to attach light-weight foam blades 12, 14, 16, 18 onto the fan hub assembly 20 to allow for an unguarded fan assembly in which a fan grill is unneeded. Further, each fan blade may preferably be attached and secured at an angle and orientation to maximize air flow.

The scope of the present invention should be determined not by the embodiments illustrated, but by the appended claims and their legal equivalents.

What is claimed is:

1. A fan assembly for creating and directing a flow of air, wherein the fan assembly comprises:
a first fan blade, a second fan blade and a third fan blade; wherein each of the first, second and third fan blades comprise:
an insertion edge; wherein the insertion edge comprises a flat insertion surface; wherein the flat insertion surface comprises a plurality of securing holes; and
a fan blade body;
a fan hub assembly, wherein the fan hub assembly comprises:
a front nose cone;
a rear supporting shell, wherein the rear supporting shell comprises a curved inner housing surface; wherein the curved inner housing surface comprises:
a first fan blade insertion aperture, a second fan blade insertion aperture and a third fan blade insertion aperture; and
a plurality of securing pins, wherein each securing pin comprises:
an insertion pin; and
a plurality of supporting ribs; wherein the supporting ribs extend from the insertion pin to the curved inner housing surface;
wherein at least a first group of three securing pins are formed on the curved inner housing surface adjacent to the first fan blade insertion aperture; wherein at least a second group of three securing pins are formed on the curved inner housing surface adjacent to the second fan blade insertion aperture; wherein at least a third group of three securing pins are formed on the curved inner housing surface adjacent to the third fan blade insertion aperture;
wherein the first blade is inserted through the first blade aperture and the first group of three securing pins are inserted through the first blade securing holes; wherein the plurality of supporting ribs of the first group of three securing pins align the first blade into a first thrust orientation;
wherein the second blade is inserted through the second blade aperture and the second group of three securing pins are inserted through the second blade securing holes; wherein the plurality of supporting ribs of the second group of three securing pins align the second blade into a second thrust orientation; and
wherein the third blade is inserted through the third blade aperture and the third group of three securing pins are inserted through the third blade securing holes; wherein the plurality of supporting ribs of the third group of three securing pins align the third blade into a third thrust orientation;
wherein the first, second and third thrust orientations are angled to form and direct a single, uniform column of air.

2. The fan assembly of claim 1, wherein the first, second and third fan blades are tilted towards the nose cone.

3. The fan assembly of claim 1, wherein the first, second and third fan blades are tilted away from the nose cone.

4. The fan assembly of claim 1, wherein the fan blades are formed of injection molded materials.

5. The fan assembly of claim 4, wherein the fan blades are formed of materials selected from the group of materials comprising: Polypropylene (PP), High Density Polyethylene (HDPE), Low Density Polyethylene (LDPE), ABS Plastics, Acrylic, Polyurethane (PU), Nylon (PA), and Thermoplastic Elastomer (TPE).

6. The fan assembly of claim 4, wherein the fan blades are formed of materials selected from the group of materials comprising: Thermoplastic Polyurethane Elastomer Engineering Thermoplastic, Polycarbonate (PC), Polystyrene (PS), High Impact Polystyrene (HIPS), Polybutylene Terephthalate (PBT), Polyetherimide (PEI), and Polyphenylene Sulfide (PPS).

7. The fan assembly of claim 1, wherein the fan blades are formed of a light-weight foam material.

8. The fan assembly of claim 7, wherein the fan blades are formed closed cell material.

9. The fan assembly of claim 7, wherein the fan blades are formed of open cell material.

10. The fan assembly of claim 7, wherein the fan blades are formed of materials selected from the group of materials comprising: Crosslinked Polyethylene, ethylyene-vynyl acetate (EVA), Volara, FloTex, and Neoprene

11. The fan assembly of claim 7, wherein each securing pin is heat staked to secure each blade to the hub assembly.
